(19) United States
(12) Patent Application Publication
(10) Pub. No.: US 2025/0147485 A1
(43) Pub. Date: May 8, 2025

(54) LARGE LANGUAGE MODEL (LLM) POWERED FRAMEWORK FOR USE WITH CODE USED WITH ADDITIVE AND/OR SUBTRACTIVE MANUFACTURING

(71) Applicants: New York University, New York, NY (US); Iowa State University Research Foundation, Ames, IA (US)

(72) Inventors: Chinmay Hegde, New York, NY (US); Adarsh Krishnamurty, Ames, IA (US); Aditya Balu, Ames, IA (US); Baskar Ganapathysubramanian, Ames, IA (US)

(21) Appl. No.: 18/939,109

(22) Filed: Nov. 6, 2024

Related U.S. Application Data
(60) Provisional application No. 63/596,928, filed on Nov. 7, 2023.

(51) Int. Cl. G05B 19/4099; G06F 40/40

(52) U.S. Cl. CPC G05B 19/4099; G05B 2219/49023; G06F 40/40

(57) ABSTRACT

A multimodal, large language model (LLM)-powered smart service specifically tailored for manufacturing quality G-Code is described. This LLM can be considered as an information encoder that compiles the information from input data of various modalities into a shared numerical representation (or embedding). The various modalities in an example database used by the LLM and/or used to train the LLM, correspond to different representations of the part under consideration, such as design specifications, G-code, and CAD models. This embedding can then be used for different downstream tasks, such as verifying, debugging, indexing, etc., of a potentially vast set of G-Code files.

### § 2. RELATED APPLICATION(S)

The present application claims benefit to the filing date of provisional application Ser. No. 63/596,928 (referred to as “the '928 provisional” and incorporated herein by reference), filed on Nov. 7, 2024, titled “LLM-POWERED FRAMEWORK FOR G-CODE COMPREHENSION AND RETRIEVAL,” and listing Chinmay HEGDE, Adarsh KRISHNAMURTY, Aditya BALU, and Baskar GANAPATHYSUBRAMANIAN as the inventors. The present invention is not limited to any requirements or specific embodiments in the '928 provisional.

### § 1. FEDERAL FUNDING

This invention was made with government support under CMMI2347623 and CMMI2347624 awarded by the National Science Foundation. The government has certain rights in the invention.

### § 3. BACKGROUND OF THE INVENTION

The disclosure in this section should not be construed as an admission of prior art.

### § 3.1 Field of the Invention

The present invention concerns manufacturing, such as manufacturing three-dimensional (3D) objects. In particular, the present invention concerns G-code, used in additive manufacturing.

### § 3.2 Background Information § 3.2.1 Generating 3D Objects Using Additive Printing and G-Code

Professional designers traditionally rely on computer-aided design (CAD) modeling to define the geometric properties of desired parts. A process (or manufacturing) engineer converts these designs to machine-tool specifications, which are typically expressed in G-Code. Therefore, G-Code files encode both the design intent as well as manufacturing specifications for the part under consideration.

In recent years, the integration of digital design and computer-aided manufacturing processes has led to major innovations in the manufacturing sector. One of the most transformative technologies at this intersection is additive manufacturing or 3D printing, which enables the physical manufacturing of digital assets. 3D printing surpasses the limitations of traditional manufacturing techniques by enabling the creation of parts with complex geometric shapes.

A commonly used 3D printing method is extrusion-based additive manufacturing, often based on Fused Deposition Modeling (FDM) for manufacturing plastic or polymer parts. With FDM 3D printing, bits of thermoplastic material are sequentially extruded from a heated nozzle, which has three degrees of freedom. The nozzle moves in flat 2D planes (or layers), and builds up the desired shape layer-by-layer.

A typical 3D printing process begins with creating a 3D model of the part in a computer-aided design (CAD) program. This CAD model is then usually exported as a triangulated mesh file (for example, STL, PLY, or OBJ). The triangulated model is then “sliced” into multiple layers based on the resolution or the layer height of the 3D printer. Each layer is then converted into a sequence of programmatic instructions for the movement of the 3D printer's nozzle and extrusion of material along the boundary or “contour” of each layer. The instructions also include the movement of the nozzle and extrusion of material inside the contours or the “infill”.

These instructions are then directly sent to the 3D printer for physical manufacturing. The most common representation for storing this information is G-code (Geometric code) or RS-274, a computer numerical control (CNC) programming language. G-code provides machine instructions for the movement of the 3D printer, especially for the nozzle, stage, and extrusion of material for extrusion-based additive manufacturing. G-code provides an intermediary between digital design and physical manufacturing, providing an expressive language-based representation for 3D objects. For example, the most straightforward G-code command is G1 which directs the 3D printer to move its nozzle towards a spatial coordinate. This is usually followed by a coordinate in the form Xaaa Yaaa, where movement along the X and Y axes are given by a specific numeric value aaa. For extrusion-based 3D printers, a thermoplastic material is extruded from a heated nozzle that has three degrees of freedom. An example extrusion move is given by G1 X50.6 Y36.2 E2.3, where the nozzle moves 50.6 units along X, 36.2 units along Y and extrudes 2.3 units of material. Other commands instruct the printer to change settings such as the material/ink feed rate, or perform more complex movements without extruding material.

Although some extensions of G-code have been written to include basic abstractions such as for-loops, the vast majority of G-code in use consists mainly of low-level instructions that provide a sequence of commands to be carried out by the 3D printer.

Since 3D printing is a layered manufacturing process, it requires performing the slicing process. The slicing process operates on the entire object and splits it along the print direction (usually the Z-axis by default). Each layer is then used to generate the printer instructions for contour and infill. However, achieving high-quality fabricated models often requires manual tuning of the slicing software. The iterative improvement of a given G-code file to produce a 3D-printed model that exactly matches its CAD representation is a non-trivial challenge. In addition, there are several “flavors” of G-code files depending on the compatibility of the 3D printer's controller hardware. Due to the low-level nature of G-code, manually debugging a G-code file is cumbersome, if not impossible. Features such as line-level and layer-level natural language comments are very rare. While custom solutions such as regular expression matching could be leveraged for correcting G-code, they fall under a rigid set of methods and are not generalizable.

### § 3.2.2 Using Large Language Models (LLMs) to Code

LLMs have also been used for programming language analysis and code generation. Coding-focused LLMs are mainly trained on a mix of web-scraped data, coding repositories, and instructions and often surpass general-purpose LLMs in code-related tasks. Current research has led to many such models. (See, e.g., the documents: Loubna Ben Allal, Raymond Li, Denis Kocetkov, Chenghao Mou, Christopher Akiki, Carlos Munoz Ferrandis, Niklas Muennighoff, Mayank Mishra, Alex Gu, Manan Dey, et al. Santacoder: don't reach for the stars! arXiv preprint arXiv: 2301.03988, 2023 (incorporated herein by reference); Fenia Christopoulou, Gerasimos Lampouras, Milan Gritta, Guchun Zhang, Yinpeng Guo, Zhongqi Li, Qi Zhang, Meng Xiao, Bo Shen, Lin Li, et al. Pangu-coder: Program synthesis with function-level language modeling. arXiv preprint arXiv: 2207.11280, 2022 (incorporated herein by reference); Bo Shen, Jiaxin Zhang, Taihong Chen, Daoguang Zan, Bing Geng, An Fu, Muhan Zeng, Ailun Yu, Jichuan Ji, Jingyang Zhao, et al. Pangu-coder2: Boosting large language models for code with ranking feedback. arXiv preprint arXiv: 2307.14936, 2023 (incorporated herein by reference); Sahil Chaudhary. instruct-codegen, 2024, available online at huggingface.co/sahil2801/instruct-codegen-16B (incorporated herein by reference); Josh Achiam, Steven Adler, Sandhini Agarwal, Lama Ahmad, Ilge Akkaya, Florencia Leoni Aleman, Diogo Almeida, Janko Altenschmidt, Sam Altman, Shyamal Anadkat, et al. Gpt-4 technical report. arXiv preprint arXiv: 2303.08774, 2023 (incorporated herein by reference); and Ziyang Luo, Can Xu, Pu Zhao, Qingfeng Sun, Xiubo Geng, Wenxiang Hu, Chongyang Tao, Jing Ma, Qingwei Lin, and Daxin Jiang. Wizardcoder: Empowering code large language models with evol-instruct. arXiv preprint arXiv: 2306.08568, 2023 (incorporated herein by reference).). Most notable ones include WizardCoder (See, e.g., Ziyang Luo, Can Xu, Pu Zhao, Qingfeng Sun, Xiubo Geng, Wenxiang Hu, Chongyang Tao, Jing Ma, Qingwei Lin, and Daxin Jiang. Wizardcoder: Empowering code large language models with evol-instruct. arXiv preprint arXiv: 2306.08568, 2023 (incorporated herein by reference).), Code Llama (See, e.g., Baptiste Roziere, Jonas Gehring, Fabian Gloeckle, Sten Sootla, Itai Gat, Xiaoqing Ellen Tan, Yossi Adi, Jingyu Liu, Tal Remez, Jérémy Rapin, et al. Code llama: Open foundation models for code. arXiv preprint arXiv: 2308.12950, 2023. (incorporated herein by reference).), and Instruct-CodeGen (See, e.g., Sahil Chaudhary. instruct-codegen, 2024, available online at huggingface.co/sahil2801/instruct-codegen-16B (incorporated herein by reference).). Codex (See, e.g., Mark Chen, Jerry Tworek, Heewoo Jun, Qiming Yuan, Henrique Ponde de Oliveira Pinto, Jared Kaplan, Harri Edwards, Yuri Burda, Nicholas Joseph, Greg Brockman, et al. Evaluating large language models trained on code. arXiv preprint arXiv: 2107.03374, 2021 (incorporated herein by reference).) is an early model deployed under Github's Copilot feature and acts as an integrated development environment (IDE) assistant that can understand local code context, make suggestions, and generate entire blocks of code.

### § 3.2.3 Using LLMs for Various Tasks in the 3D Domain

Language understanding methods have been applied in the 3D domain for a wide array of tasks including 3D captioning (See, e.g., the documents: Tiange Luo, Chris Rockwell, Honglak Lee, and Justin Johnson. Scalable 3D captioning with pretrained models. arXiv preprint arXiv: 2306.07279, 2023 (incorporated herein by reference); and Rao Fu, Jingyu Liu, Xilun Chen, Yixin Nie, and Wenhan Xiong. Scene-Ilm: Extending language model for 3d visual understanding and reasoning. arXiv preprint arXiv: 2403.11401, 2024 (incorporated herein by reference).), object grounding (See, e.g., the documents: Yining Hong, Haoyu Zhen, Peihao Chen, Shuhong Zheng, Yilun Du, Zhenfang Chen, and Chuang Gan. 3D-LLM: Injecting the 3D world into large language models. arXiv, 2023 (incorporated herein by reference); and Panos Achlioptas, Ahmed Abdelreheem, Fei Xia, Mohamed Elhoseiny, and Leonidas J. Guibas. ReferIt3D: Neural listeners for fine-grained 3D object identification in real-world scenes. In European Conference on Computer Vision (ECCV), volume 12346, pages 422-440. Springer, 2020 (incorporated herein by reference).), 3D conversation (See, e.g., Zehan Wang, Haifeng Huang, Yang Zhao, Ziang Zhang, and Zhou Zhao. Chat-3D: Data-efficiently tuning large language model for universal dialogue of 3D scenes. CoRR, abs/2308.08769, 2023. doi: 10.48550/ARXIV.2308.08769, available online at doi.org/10.48550/arXiv.2308.08769 (incorporated herein by reference).), and text-conditioned generation (See, e.g., the documents: Yawar Siddiqui, Antonio Alliegro, Alexey Artemov, Tatiana Tommasi, Daniele Sirigatti, Vladislav Rosov, Angela Dai, and Matthias Nießner. MeshGPT: Generating triangle meshes with decoder-only transformers. arXiv preprint arXiv: 2311.15475, 2023 (incorporated herein by reference); and Fukun Yin, Xin Chen, Chi Zhang, Biao Jiang, Zibo Zhao, Jiayuan Fan, Gang Yu, Taihao Li, and Tao Chen. ShapeGPT: 3D shape generation with a unified multi-modal language model. CoRR, abs/2311.17618, 2023, available online at doi.org/10.48550/arXiv.2311.17618 (incorporated herein by reference).). Recently, there has been a surge of interest in multimodal large language models (MLLMs). MLLMs combine the language-based reasoning and knowledge of LLMs with the ability to comprehend other data modalities. Vision-augmented LLMs (See, e.g., the documents: Haotian Liu, Chunyuan Li, Qingyang Wu, and Yong Jae Lee. Visual instruction tuning. In NeurIPS, 2023 (incorporated herein by reference); Junnan Li, Dongxu Li, Silvio Savarese, and Steven Hoi. BLIP-2: Bootstrapping language-image pre-training with frozen image encoders and large language models, 2023 (incorporated herein by reference); and Deyao Zhu, Jun Chen, Xiaoqian Shen, Xiang Li, and Mohamed Elhoseiny. MiniGPT-4: Enhancing vision-language understanding with advanced large language models. arXiv preprint arXiv: 2304.10592, 2023 (incorporated herein by reference).) encode images into an LLM's embedding space. These methods have been subsequently extended to the 3D domain for different forms of 3D representation, such as point clouds (See, e.g., the documents: Runsen Xu, Xiaolong Wang, Tai Wang, Yilun Chen, Jiangmiao Pang, and Dahua Lin. Pointllm: Empowering large language models to understand point clouds. arXiv preprint arXiv: 2308.16911, 2023 (incorporated herein by reference); and Zhangyang Qi, Ye Fang, Zeyi Sun, Xiaoyang Wu, Tong Wu, Jiaqi Wang, Dahua Lin, and Hengshuang Zhao. Gpt4point: A unified framework for point-language understanding and generation. In CVPR, 2024 (incorporated herein by reference).), and sparse outdoor LiDAR data (See, e.g., Senqiao Yang, Jiaming Liu, Ray Zhang, Mingjie Pan, Zoey Guo, Xiaoqi Li, Zehui Chen, Peng Gao, Yandong Guo, and Shanghang Zhang. Lidar-Ilm: Exploring the potential of large language models for 3d lidar understanding. CoRR, abs/2312.14074, 2023. doi: 10.48550/ARXIV.2312. 14074, available online at doi.org/10.48550/arXiv.2312.14074 (incorporated herein by reference).). Paschalidou et al. (See, e.g., Despoina Paschalidou, Amlan Kar, Maria Shugrina, Karsten Kreis, Andreas Geiger, and Sanja Fidler. Atiss: Autoregressive transformers for indoor scene synthesis. In Advances in Neural Information Processing Systems (NeurIPS), 2021 (incorporated herein by reference).) use a transformer-based model (not LLM) to autoregressively predict 3D objects in a scene. 3DLLM (See, e.g., Yining Hong, Haoyu Zhen, Peihao Chen, Shuhong Zheng, Yilun Du, Zhenfang Chen, and Chuang Gan. 3D-LLM: Injecting the 3D world into large language models. arXiv, 2023 (incorporated herein by reference).) maps 3D scenes to a set of 2D image embeddings and uses a query-token embedding technique based on BLIP-2's Q-Former (See, e.g., Junnan Li, Dongxu Li, Silvio Savarese, and Steven Hoi. BLIP-2: Bootstrapping language-image pre-training with frozen image encoders and large language models, 2023 (incorporated herein by reference).) to perform a diverse set of 3D-related tasks. GPT4Point (See, e.g., Zhangyang Qi, Ye Fang, Zeyi Sun, Xiaoyang Wu, Tong Wu, Jiaqi Wang, Dahua Lin, and Hengshuang Zhao. Gpt4point: A unified framework for point-language understanding and generation. In CVPR, 2024 (incorporated herein by reference).) also leverages a similar Q-Former for point text feature alignment. Chat3D (See, e.g., Zehan Wang, Haifeng Huang, Yang Zhao, Ziang Zhang, and Zhou Zhao. Chat-3D: Data-efficiently tuning large language model for universal dialogue of 3D scenes. CoRR, abs/2308.08769, 2023. doi: 10.48550/ARXIV.2308.08769, available online at doi.org/10. 48550/arXiv.2308.08769 (incorporated herein by reference).) uses an object-centric 3D representation to train a 3D-LLM for dialogue. Feng et al. (See, e.g., Weixi Feng, Wanrong Zhu, Tsu jui Fu, Varun Jampani, Arjun Akula, Xuehai He, Sugato Basu, Xin Eric Wang, and William Yang Wang. Layoutgpt: Compositional visual planning and generation with large language models, 2023 (incorporated herein by reference).) does in-context learning on room layouts from the 3D-FRONT dataset (See, e.g., Huan Fu, Bowen Cai, Lin Gao, Ling-Xiao Zhang, Jiaming Wang, Cao Li, Qixun Zeng, Chengyue Sun, Rongfei Jia, Binqiang Zhao, et al. 3d-front: 3d furnished rooms with layouts and semantics, In Proceedings of the IEEE/CVF International Conference on Computer Vision, pages 10933-10942, 2021 (incorporated herein by reference).). PointBERT (See, e.g., Xumin Yu, Lulu Tang, Yongming Rao, Tiejun Huang, Jie Zhou, and Jiwen Lu. Point-BERT: Pre-training 3D point cloud transformers with masked point modeling. In IEEE/CVF Conference on Computer Vision and Pattern Recognition, CVPR, pages 19291-19300. IEEE, 2022, available online at doi.org/10.1109/CVPR52688.2022.01871 (incorporated herein by reference).) did some early work on point-cloud representation learning with transformers. Fu et al. (See, e.g., Rao Fu, Jingyu Liu, Xilun Chen, Yixin Nie, and Wenhan Xiong. Scene-Ilm: Extending language model for 3d visual understanding and reasoning. arXiv preprint arXiv: 2403.11401, 2024 (incorporated herein by reference).) align visual features from 3D scenes with text to finetune a LLaMa-2-chat-70B (See, e.g., Hugo Touvron, Thibaut Lavril, Gautier Izacard, Xavier Martinet, Marie-Anne Lachaux, Timothée Lacroix, Baptiste Rozière, Naman Goyal, Eric Hambro, Faisal Azhar, Aurelien Rodriguez, Armand Joulin, Edouard Grave, and Guillaume Lample. LLaMA: Open and efficient foundation language models, 2023 (incorporated herein by reference).) model for scene understanding and question answering.

### § 3.2.4 Using LLMs for Design and Manufacturing

Recent research has shown that natural language descriptions can be used for various tasks related to 3D printing, such as generating novel shapes (See, e.g., the documents: Aditya Sanghi, Hang Chu, Joseph G Lambourne, Ye Wang, Chin-Yi Cheng, Marco Fumero, and Kamal Rahimi Malekshan. Clip-forge: Towards zero-shot text-to-shape generation. In Proceedings of the IEEE/CVF Conference on Computer Vision and Pattern Recognition, pages 18603-18613, 2022 (incorporated herein by reference); Kelly O Marshall, Minh Pham, Ameya Joshi, Anushrut Jignasu, Aditya Balu, and Adarsh Krishnamurthy Chinmay Hegde. Zeroforge: Feedforward text-to-shape without 3d supervision. arXiv preprint arXiv: 2306.08183, 2023 (incorporated herein by reference); Ajay Jain, Ben Mildenhall, Jonathan T Barron, Pieter Abbeel, and Ben Poole. Zero-shot text-guided object generation with dream fields. In Proceedings of the IEEE/CVF Conference on Computer Vision and Pattern Recognition, pages 867-876, 2022 (incorporated herein by reference); and Chen-Hsuan Lin, Jun Gao, Luming Tang, Towaki Takikawa, Xiaohui Zeng, Xun Huang, Karsten Kreis, Sanja Fidler, Ming-Yu Liu, and Tsung-Yi Lin. Magic3d: High-resolution text-to-3d content creation. In Proceedings of the IEEE/CVF Conference on Computer Vision and Pattern Recognition, pages 300-309, 2023 (incorporated herein by reference).), editing scenes (See, e.g., Ayaan Haque, Matthew Tancik, Alexei A Efros, Aleksander Holynski, and Angjoo Kanazawa. Instruct-nerf2nerf: Editing 3d scenes with instructions. arXiv preprint arXiv: 2303.12789, 2023 (incorporated herein by reference).), and reasoning about geometry in the volume space (See, e.g., Justin Kerr, Chung Min Kim, Ken Goldberg, Angjoo Kanazawa, and Matthew Tancik. Lerf: Language embedded radiance fields. arXiv preprint arXiv: 2303.09553, 2023 (incorporated herein by reference).). Makatura et al. (See, e.g., Liane Makatura, Michael Foshey, Bohan Wang, Felix HähnLein, Pingchuan Ma, Bolei Deng, Megan Tjandrasuwita, Andrew Spielberg, Crystal Elaine Owens, Peter Yichen Chen, et al. How can large language models help humans in design and manufacturing? arXiv preprint arXiv: 2307.14377, 2023 (incorporated herein by reference).) thoroughly examine GPT-4's suitability for automated design and manufacturing. Badini et al. (See, e.g., Silvia Badini, Stefano Regondi, Emanuele Frontoni, and Raffaele Pugliese. Assessing the capabilities of chatgpt to improve additive manufacturing troubleshooting. Advanced Industrial and Engineering Polymer Research, 2023 (incorporated herein by reference).) use ChatGPT to modify G-code, but they only alter the parameters in the G-code header. These modifications allow them to address common errors in the 3D printing process, such as warping, bed detachment, and stringing. Kulits et al. (See, e.g., Peter Kulits, Haiwen Feng, Weiyang Liu, Victoria Abrevaya, and Michael J. Black. Re-thinking inverse graphics with large language models, 2024 (incorporated herein by reference).) train an LLM to autoregressively generate structured representations of simple 3D objects from the CLEVR dataset (See, e.g., Justin Johnson, Bharath Hariharan, Laurens van der Maaten, Li Fei-Fei, C. Lawrence Zitnick, and Ross Girshick. Clevr: A diagnostic dataset for compositional language and elementary visual reasoning. In Proceedings of the IEEE Conference on Computer Vision and Pattern Recognition (CVPR), July 2017 (incorporated herein by reference).).

### § 3.2.5 Unmet Needs

Recent, powerful language models such as GPT-4 demonstrate exceptional comprehension of human-authored text as well as code in various scripting languages. In the last few years, while advances in AI have impacted various domains, their potential in computer-aided design (CAD) and cyber manufacturing remains largely untapped. Modern LLMs and Vision-Language Models (VLMs) could provide an avenue to realize this potential. The ability of LLMs to process, comprehend, and generate natural language descriptions, code, and other text data can be leveraged to interpret, generate, and manipulate G-code. LLMs for 3D shape modeling have been shown to enable operations on meshes (See, e.g., the documents: Yawar Siddiqui, Antonio Alliegro, Alexey Artemov, Tatiana Tommasi, Daniele Sirigatti, Vladislav Rosov, Angela Dai, and Matthias Nießner. MeshGPT: Generating triangle meshes with decoder-only transformers. arXiv preprint arXiv: 2311.15475, 2023 (incorporated herein by reference); and Fukun Yin, Xin Chen, Chi Zhang, Biao Jiang, Zibo Zhao, Jiayuan Fan, Gang Yu, Taihao Li, and Tao Chen. ShapeGPT: 3D shape generation with a unified multi-modal language model. CoRR, abs/2311.17618, 2023, available online at doi.org/10.48550/arXiv.2311.17618 (incorporated herein by reference).) and point clouds (See, e.g., the documents: Yining Hong, Haoyu Zhen, Peihao Chen, Shuhong Zheng, Yilun Du, Zhenfang Chen, and Chuang Gan. 3D-LLM: Injecting the 3D world into large language models. arXiv, 2023 (incorporated herein by reference); and Runsen Xu, Xiaolong Wang, Tai Wang, Yilun Chen, Jiangmiao Pang, and Dahua Lin. Pointllm: Empowering large language models to understand point clouds. arXiv preprint arXiv: 2308.16911, 2023 (incorporated herein by reference).) G-code, with its unique language-based structure, presents distinct challenges for machine learning, mainly due to the context window limitations of current LLMs. Many existing deep-learning-based computer vision applications leverage 2D datasets (images), text descriptions, or a combination of such modalities for both supervised and self-supervised pre-training of foundation models. However, none of these datasets provide a curated avenue for training a manufacturing domain-specific foundation model. It is unfortunate that the use of language models to understand and/or generate G-code is much more challenging because G-code is not easily comprehended by humans, if at all, and because G-code are extremely long, often on the order of tens of thousands or even hundreds of thousands of lines.

It would be useful to provide an AI model or framework that natively ingests G-Code instructions and forms bidirectional mappings with natural language. This would greatly reduce the manual effort needed to verify, debug, index, and retrieve G-Code. Further, most existing G-code datasets are proprietary, limited in size and scope, and/or not publicly accessible. Therefore, it would be useful to first create a large G-code dataset from different geometries, manufacturing processes, and manufacturing parameters. Further, it would be useful to have a community-driven G-code database that can collect, store, and generate G-code files from different sources and for different manufacturing processes.

### § 4. SUMMARY OF THE INVENTION

Example methods consistent with the present description meet one or more of the unmet needs of § 3.2.5 by: (a) receiving, for each of a plurality of three-dimensional objects, a multimodal information set including (1) a three-dimensional model representation of the three-dimensional object, (2) human language information describing the three-dimensional object in human-understandable words, and (3) machine-level code for controlling a three-dimensional printer to print the three-dimensional object; (b) defining a data structure entry by grouping, for each of the information sets, (1) the three-dimensional model representation of the three-dimensional object, (2) the human language information describing the three-dimensional object in human-understandable words, and (3) the machine-level code for controlling a three-dimensional printer to print the three-dimensional object; and (c) training a machine learning network using the multimodal information sets, to perform at least one of (A) debugging machine-level code for controlling a three-dimensional printer, (B) verifying machine-level code for controlling a three-dimensional printer, (C) translating machine-level code from a first flavor to a second flavor, (D) generating machine-level code for controlling a three-dimensional printer from at least one of (i) a three-dimensional model representation of the three-dimensional object, and/or (ii) human language information describing the three-dimensional object in human-understandable words, (E) generating a human-understandable explanation of machine-level code for controlling a three-dimensional printer, from the machine-level code for controlling a three-dimensional printer, or (F) generating a three-dimensional model of an object from machine level-code for controlling a three-dimensional printer, to generate a trained machine learning network.

At least some example methods further: (d) receive proposed machine-level code for controlling a three-dimensional printer; and (c) debug or verify the proposed machine-level code received using the trained machine learning network.

At least some example methods further: (d) receive a three-dimensional model representation of a proposed three-dimensional object; and (c) generate machine-level code for controlling a three-dimensional printer to print the proposed three-dimensional object using the three-dimensional model representation of the proposed three dimensional object received and the trained machine learning network.

At least some example methods further: (d) receive human language information describing a proposed three-dimensional object in human-understandable words; and (e) generate machine-level code for controlling a three-dimensional printer to print the proposed three-dimensional object using the human language information describing the proposed three-dimensional object in human-understandable words received and the trained machine learning network.

In at least some example methods, in each case, the machine-level code for controlling a three-dimensional printer to print the three-dimensional object specifies a sequence of (1) a print head positions, and (2) an amount of material for the print head to extrude at the print head positions specified. For example, the print head position may be specified by one of (A) an absolute position, or (B) a position relative to an immediately previous position. In at least some example methods, the machine-level code for controlling a three-dimensional printer to print the three-dimensional object is G-code.

In at least some example methods, in each case, the human language information describing the three-dimensional object in human-understandable words are answers to a set of prompts about the three-dimensional object. For example, the set of prompts about the three-dimensional object may include at least one of (A) a category of the three-dimensional object, (B) a material of the three-dimensional object, (C) a toolpath strategy for printing the three-dimensional object with a three-dimensional printer, and/or (D) a geometric description of the three-dimensional object.

In at least some example methods, the act of training a machine learning network using the multimodal information sets to perform at least one of (A) debugging machine-level code for controlling a three-dimensional printer, (B) verifying machine-level code for controlling a three-dimensional printer, (C) translating machine-level code from a first flavor to a second flavor, (D) generating machine-level code for controlling a three-dimensional printer, (E) generating a human-understandable explanation of machine-level code for controlling a three-dimensional printer, from the machine-level code for controlling a three-dimensional printer, or (F) generating a three-dimensional model of an object from machine level-code for controlling a three-dimensional printer, to generate a trained machine learning network, includes tokenizing the machine-level code for controlling a three-dimensional printer to print the three dimensional object into machine-level code corresponding to at least two contiguous printer nozzle positions.

In at least some example methods, each of the three-dimensional model representations of a three-dimensional object is parsed into layers. For example, in each case, the human language information describing the three-dimensional object in human-understandable words may be answers to a set of prompts about one or more of the layers.

In at least some example methods, the act of receiving, for each of a plurality of three dimensional objects, a multimodal information set includes
receiving the three dimensional model representation of the three dimensional object,
generating, as the machine level code for controlling a three dimensional printer to print the three dimensional object, G-code from the three dimensional model by (1) slicing the three dimensional model to generate a plurality of slices, and (2) generating G-code for each of the plurality of slices,
generating a plurality of rendered views of the three dimensional model, and
generating, as the human language information describing the three dimensional object in human-understandable words, categories derived from text embeddings determined from automatic captions generated using vision language models trained using the Large Vocabulary Instance Segmentation (LVIS) dataset and image embeddings from each of the plurality of rendered view of the three dimensional model.

In at least some example methods, the act of training a machine learning network, using the multimodal information sets, to perform translating machine-level code from a first flavor to a second flavor, includes
separating the machine-level code from the first flavor into a first plurality of layers, and separating the machine-level code from the second flavor into a second plurality of layers,
decomposing each of the first plurality of layers into an first plurality of contours, and decomposing each of the second plurality of layers into an ordered second plurality of contours,
determining a bijective mapping such that a mapping of each of the ordered second plurality of contours is equivalent to a matching one of the ordered first plurality of contours, and
separating each of the first plurality of layers into one or more first chunks of contours, and each of the second plurality of layers into corresponding one or more second chunks of contours. In some example methods, the act of determining the bijective mapping includes finding, for each of the ordered first plurality of contours, a matching contour from the ordered second plurality of contours. In at lease some such implementations, the matching contours from the ordered first and second plurality of contours have matching extrusion location coordinates. In at least some implementations, the matching contours from the ordered first and second plurality of contours have matching extrusion location coordinates and at least one adjacent line in the contour with matching extrusion location coordinates. In at least some implementations, the act of finding a matching contour uses an lookup table mapping lines of the machine-level code to indices of the contours from the ordered second plurality of contours.

Any of the foregoing methods may be implemented on a device comprising: (a) at least one processor; and (b) a non-transitory storage system storing processor-executable instructions which, when executed by the at least one processor, cause the at least one processor to perform the method.

A computer-readable non-transitory storage system storing processor-executable instructions may be provided. When these processor-executable instructions are executed by at least one processor, they cause the at least one processor to perform any of the foregoing methods.

### § 5. BRIEF DESCRIPTION OF THE DRAWINGS

FIG. 1 is a flow chart of an example method for generating a trained LLM.

FIG. 2 is a flow diagram of an example method for generating a multimodal dataset in a manner consistent with the present application.

FIG. 3 illustrates an example system that may be used to generate text categories of each model in example multimodal datasets.

FIG. 4 is a flow chart of an example method for using a trained LLM to debug code.

FIG. 5 is a flow chart of an example method for using a trained LLM to verify code.

FIG. 6 illustrates an example system 610, including a multimodal database and a trained LLM for providing verification and/or debugging services.

FIG. 7 is a flow chart of an example method for training a machine learning network to translate machine-level code from a first “flavor” to a second “flavor”.

FIG. 8 is a flow chart of an example method for using a trained LLM to generate code for controlling a three-dimensional (e.g., additive manufacturing) printer from a three-dimensional model representation of a proposed three-dimensional object.

FIG. 9 is a flow chart of an example method for using a trained LLM to generate code for controlling a three-dimensional (e.g., additive manufacturing) printer from human language information describing a proposed three-dimensional object in human-understandable words.

FIG. 10 illustrates an example system that may perform one or more of the processes described, and/or store information used and/or generated by such processes.

### § 6. DETAILED DESCRIPTION

The present disclosure may involve novel methods, apparatus, message formats, and/or data structures to assist, either directly or indirectly, in one or more of (A) debugging machine level code for controlling a three dimensional (e.g., additive manufacturing) printer, (B) verifying machine level code for controlling a three dimensional (e.g., additive manufacturing) printer, (C) translating machine level code from a first “flavor” (e.g., a first 3D printer make and/or model) to a second “flavor”, (D) generating machine level code for controlling a three dimensional (e.g., additive manufacturing) printer from at least one of (i) a three dimensional model representation (e.g., a CAD file) of the three dimensional object, and/or (ii) human language information describing the three dimensional object in human-understandable words (e.g., textual or audible natural language), (E) generating a human understandable explanation of machine level code for controlling a three dimensional (e.g., additive manufacturing) printer, from the machine level code for controlling a three dimensional printer, and/or (F) generating a three dimensional model of an object from machine level code for controlling a three dimensional (e.g., additive manufacturing) printer, to generate a trained machine learning network (e.g., trained LLM). The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 6.1 Framework and Associated Method(s)

We describe an innovative, large-scale, smart data management system for G-code (a set of instructions used in machine tool-controlled manufacturing processes). This innovation is powered by a novel multimodal large language model (LLM) tailored specifically for the manufacturing pipeline.

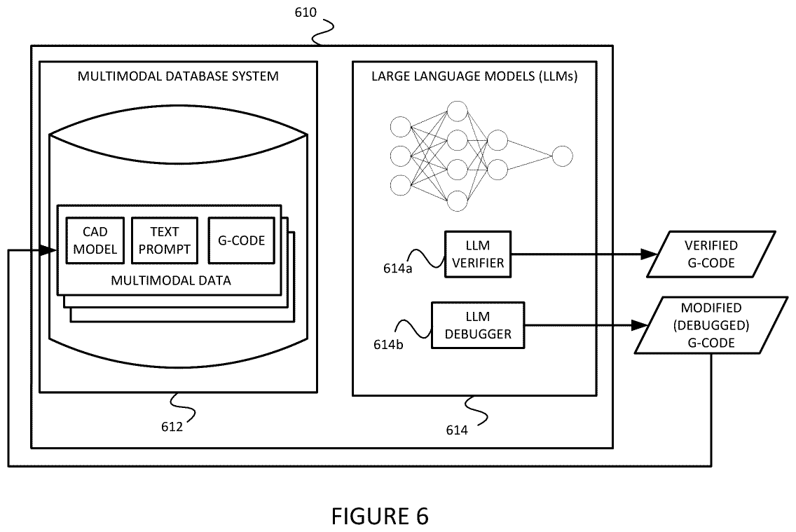

The system illustrated in FIG. 6 (described later) enables a large, curated dataset of manufacturable designs, G-code, and associated meta data that can serve as a seed for more complex downstream tasks such as geometric reasoning part retrieval and shape matching. Such an ecosystem will allow small and medium-scale industries nationwide to quickly gain access to high-quality manufacturing services that would otherwise be out of reach due to the need for heavy manual intervention, excessive computing requirements, and/or high costs.

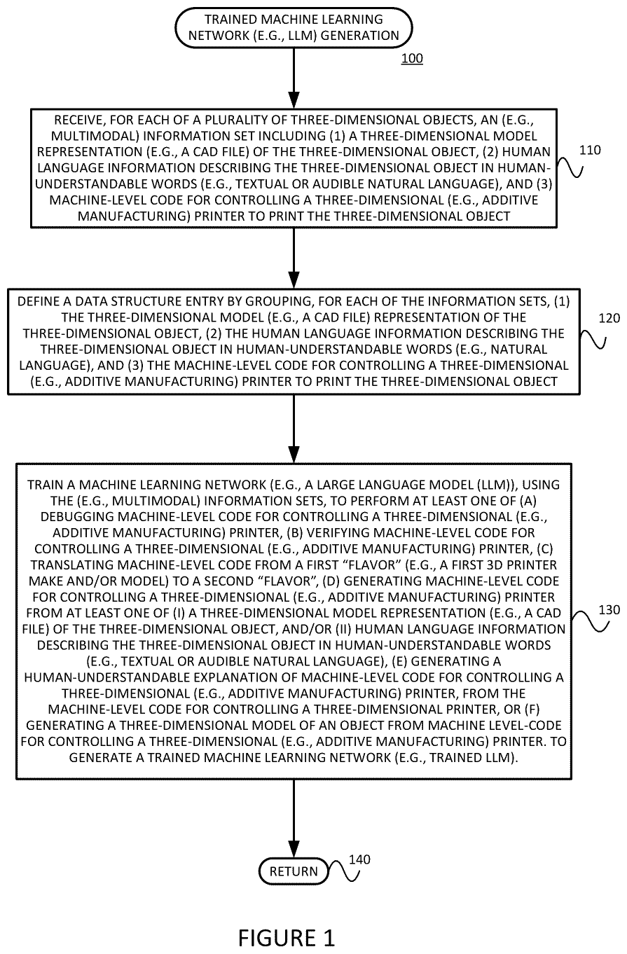

FIG. 1 is a flow chart of an example method 100 for generating a trained LLM. As shown, the example method 100 receives (or possibly generates), for each of a plurality of three-dimensional objects, an (e.g., multimodal) information set including (1) a three-dimensional model representation (e.g., a CAD file) of the three-dimensional object, (2) human language information describing the three-dimensional object in human-understandable words (e.g., textual or audible natural language), and (3) machine-level code for controlling a three-dimensional (e.g., additive manufacturing) printer to print the three-dimensional object. (Block 110) The example method 100 then defines a data structure entry by grouping, for each of the information sets, (1) the three-dimensional model (e.g., a CAD file) representation of the three-dimensional object, (2) the human language information describing the three-dimensional object in human-understandable words (e.g., natural language), and (3) the machine-level code for controlling a three-dimensional (e.g., additive manufacturing) printer to print the three-dimensional object. (Block 120) Next, the example method 100 trains a machine learning network (e.g., a large language model (LLM)), using the (e.g., multimodal) information sets, to perform at least one of (A) debugging machine-level code for controlling a three-dimensional (e.g., additive manufacturing) printer, (B) verifying machine-level code for controlling a three-dimensional (e.g., additive manufacturing) printer, (C) translating machine-level code from a first “flavor” (e.g., a first 3D printer make and/or model) to a second “flavor”, (D) generating machine-level code for controlling a three-dimensional (e.g., additive manufacturing) printer from at least one of (i) a three-dimensional model representation (e.g., a CAD file) of the three-dimensional object, and/or (ii) human language information describing the three-dimensional object in human-understandable words (e.g., textual or audible natural language), (E) generating a human-understandable explanation of machine-level code for controlling a three-dimensional (e.g., additive manufacturing) printer, from the machine-level code for controlling a three-dimensional printer, and/or (F) generating a three-dimensional model of an object from machine level-code for controlling a three-dimensional (e.g., additive manufacturing) printer, to generate a trained machine learning network (e.g., trained LLM). (Block 130).

### § 6.1.1 Collecting and/or Assembling Multimodal Data Sets

Referring back to block 110 of FIG. 1, at least some example implementations of the method 100 generates and/or assembles, for each of a plurality of three-dimensional objects, an (e.g., multimodal) information set. This subsection describes methods for generating and/or assembling a curated multimodal dataset of G-code, CAD models, renderings, and geometric properties to facilitate the application of VLMs for additive manufacturing. This should encourage the research community to address new problems in the design and manufacturing space.

One example dataset, built using models from ObjaverseXL and the Thingi10k dataset, encompasses a diverse range of 3D printable objects and provides a comprehensive resource for training a manufacturing domain-specific foundation model. The example dataset includes more than 100,000 G-code files along with their corresponding STL CAD files, renderings, LVIS (Large Vocabulary Instance Segmentation) categories, and geometric properties. The present inventors have evaluated existing LLMs for G-code geometric transformations in order to evaluate their example dataset.

We believe that this multimodal dataset will be the starting point for a foundation model in digital manufacturing.

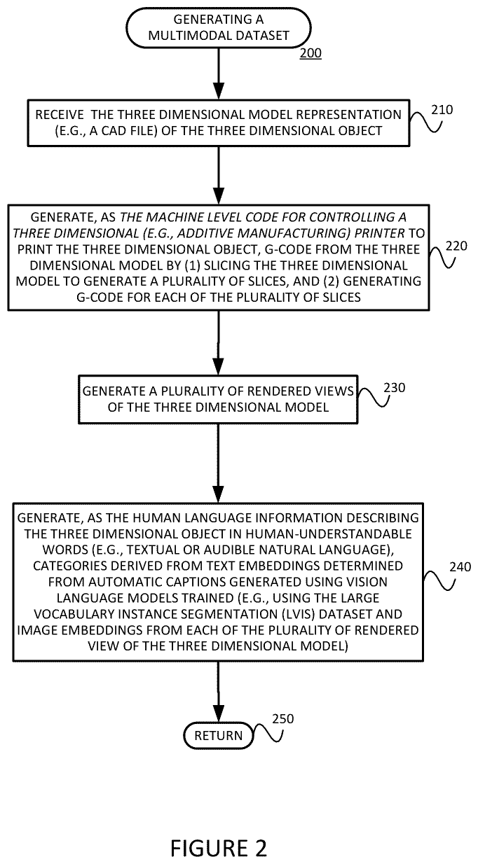

FIG. 2 is a flow diagram of an example method 200 for generating a multimodal dataset in a manner consistent with the present application. As shown, the example method 200 receives the three dimensional model representation (e.g., a CAD file) of the three dimensional object. (Block 210) The example method 200 then generates, as the machine level code for controlling a three dimensional (e.g., additive manufacturing) printer to print the three dimensional object, G-code from the three dimensional model by (1) slicing the three dimensional model to generate a plurality of slices, and (2) generating G-code for each of the plurality of slices. (Block 220) The example method 200 then generates a plurality of rendered views of the three dimensional model. (Block 230) The example method 200 also generates, as the human language information describing the three dimensional object in human-understandable words (e.g., textual or audible natural language), categories derived from text embeddings determined from automatic captions generated using vision language models trained (e.g., using the Large Vocabulary Instance Segmentation (LVIS) dataset and image embeddings from each of the plurality of rendered view of the three dimensional model). (Block 240)

One example multimodal dataset is built using Objaverse-XL's openly available 3D dataset and Thingi10K dataset. Specifically, STL models may be downloaded from the Thingiverse branch of ObjaverseXL since these are solid models specifically designed to be additively manufacturable. Models may then be filtered from the Thingi10K dataset using the following keywords: num components=1; is “manifold”; and is “oriented”. A summary the example dataset is shown in Table 1.

TABLE 1

| Source | Number of Objects |
|---|---|
| Objaverse-XL (Thingiverse) | 96,479 |
| Thingi 10k | 3,589 |
| Total | 100,068 |

Each data source is described below. In addition to providing STL models, the example dataset includes renderings, descriptive captions, and detailed geometric properties. The metadata for each model may be generated using Open3D, a library that facilitates the processing and analysis of 3D data. Key geometric properties such as vertex manifold, edge manifold, and vertex count may be calculated and included in the dataset. These properties are useful for understanding the structural characteristics of the models and can be leveraged in various applications, such as model optimization and error detection in 3D printing. Other datasets, such as the ABC dataset (See, e.g., S. Koch, A. Matveev, Z. Jiang, F. Williams, A. Artemov, E. Bumacv, M. Alexa, D. Zarin, and D. Panozzo, “ABC: A big CAD model dataset for geometric deep learning,” in Proceedings of the IEEEICVF conference on computer vision and pattern recognition, 2019, pp. 9601-9611 (incorporated herein by reference).), which contains over one million 3D models from various domains and categories, may be used instead or, or in addition to, the datasets in Table 1.

Referring to the first row of Table 1, the Objaverse-XL dataset comprises of 3D objects gathered from Github, Thingiverse, Smithsonian Institution, Polycam, and Sketchfab. Data may be gathered from the Thingiverse subset of Objaverse-XL. Thingiverse is one of the largest online platforms consisting of user-generated digital designs and is particularly focused on 3D printable files, encouraging community interaction and collaboration. A majority of these files are provided in the STL format and are available under Creative Commons licenses. The models on Thingiverse cover a wide range of categories, including functional parts, artistic creations, and educational tools. This extensive and diverse collection makes it an invaluable resource for creating comprehensive datasets for additive manufacturing.

Referring to the second row of Table 1, the Thingi10K dataset (See, e.g., Qingnan Zhou and Alec Jacobson. Thingi10k: A dataset of 10,000 3D-printing models. arXiv preprint arXiv: 1605.04797, 2016 (incorporated herein by reference).) is a collection of 10,000 3D models sourced from Thingiverse. It is specifically curated for research purposes and provides a diverse set of models that are manifold and oriented, making them ideal for various computational geometry and 3D printing research applications. The dataset includes metadata and annotations that facilitate the development of machine learning models and other computational tools.

Referring back to block 220 of FIG. 2, the G-code generation process is an important part of generating the example multimodal dataset. The command line functionality of PrusaSlicer (available online) may be used to slice all of the models. For example, each model may be sliced using two distinct G-code flavors—Sailfish and Marlin. Prusa's slicer is an open-source and widely-used slicing software that prepares 3D models for printing by converting them into G-code (which provides specific instructions for 3D printers). Additionally, PrusaSlicer allows for extensive configuration options, supporting fine-tuning of print settings such as layer height, infill density, and support structures. This flexibility ensures that the generated G-code is high quality and suitable for different 3D printers and printing conditions. Furthermore, to minimize the footprint of the data, G-code files may be generated in the binary G-code (.bgcode) format, a functionality recently incorporated by Prusa's slicer.

An important aspect of the slicing pipeline is the infill pattern selection, primarily due to its impact on total print time and structural properties of manufactured models. To encourage diversity among G-code files with respect to structural properties, while slicing each STL file, four different infill patterns ((1) Gyroid, which is empirically known to give equal strength across all directions and optimizes for a quicker print time; (2) Honeycomb, which uses a grid of hexagons, providing increased mechanical resistance, and non-crossing paths; (3) Cubic, which introduces crossing paths, potentially generating air-pockets; and (4) Grid, which uses a two-way checkerboard-like pattern for faster infill) may be selected randomly.

Blender (available online) rendering scripts, made available by Objaverse-XL, may be used to generate renderings of our STL files. In one example implementation, the Blender rendering scripts were modified to generate a total of ten (10) views for each object-six (6) orthogonal views (front, back, top, bottom, left, right) and four (4) isometric views (e.g., captured from top four corners of a cube). In one example implementation, each object is rendered with a random color. These renderings may be used for object category generation.

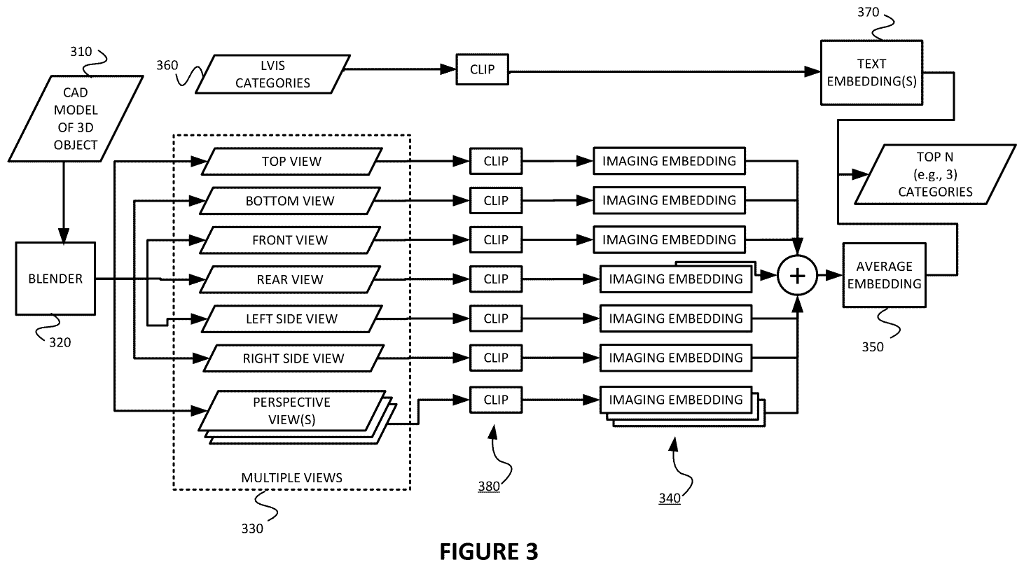

The system illustrated in FIG. 3 may be used to generate the text category of each model in example multimodal datasets. As one example, each model in the dataset may be assigned the top three (3) of the 1200+LVIS (Large Vocabulary Instance Segmentation) categories (See, e.g., Agrim Gupta, Piotr Dollar, and Ross Girshick. Lvis: A dataset for large vocabulary instance segmentation. In Proceedings of the IEEE/CVF conference on Computer Vision and Pattern Recognition (CVPR), pages 5356-5364, 2019 (incorporated herein by reference).). This helps enhance the utility of the multimodal dataset, enabling better categorization and facilitating more effective use in various research and development applications.

As discussed above, and referring to FIG. 3, for each CAD model 310, multiple (e.g., ten) views 330 may be generated using Blender 320. This ensures comprehensive visual coverage of the CAD model, capturing its geometry from various angles. The generated renderings may then serve as input to a pre-trained Vision-Language model to generate image embeddings 340. As one example, a pre-trained CLIP-ViT-L-14 (See, e.g., Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pages 8748-8763 PMLR, 2021 (incorporated herein by reference); and OpenAI. CLIP-ViT-L/14 (available online).) 380 may be used to obtain embeddings for each view. To integrate information from multiple views, an average embedding 350 may be generated for each object. This average embedding 350 combines the features from all views 330 into a single, unified representation, providing a comprehensive summary of the visual characteristics of the object.

In parallel, the 1200+ LVIS categories 360 may be processed to obtain the text embeddings 370 for all categories. Using the average embedding 350, each object is then matched to the closest categories in the text embedding 370. By comparing the average embeddings 350, the top three (3) most relevant LVIS categories 390 for each object in the example dataset may be identified.

The current research community has proposed and leveraged various 3D datasets. (See, e.g., the documents: Jasmine Collins, Shubham Goel, Kenan Deng, Achleshwar Luthra, Leon Xu, Erhan Gundogdu, Xi Zhang, Tomas F. Yago Vicente, Thomas Dideriksen, Himanshu Arora, Matthieu Guillaumin, and Jitendra Malik. ABO: dataset and benchmarks for real-world 3d object understanding. In IEEE/CVF Conference on Computer Vision and Pattern Recognition, CVPR 2022, New Orleans, LA, USA, Jun. 18-24, 2022, pages 21094-21104 IEEE, 2022. doi: 10.1109/CVPR52688.2022. 02045, available online at doi.org/10.1109/CVPR52688.2022.02045 (incorporated herein by reference); Angel X. Chang, Thomas A. Funkhouser, Leonidas J. Guibas, Pat Hanrahan, Qi-Xing Huang, Zimo Li, Silvio Savarese, Manolis Savva, Shuran Song, Hao Su, Jianxiong Xiao, Li Yi, and Fisher Yu. Shapenet: An information-rich 3d model repository. CoRR, abs/1512.03012, 2015, available online at arxiv.org/abs/1512.03012 (incorporated herein by reference); Matt Deitke, Dustin Schwenk, Jordi Salvador, Luca Weihs, Oscar Michel, Eli VanderBilt, Ludwig Schmidt, Kiana Ehsani, Aniruddha Kembhavi, and Ali Farhadi. Objaverse: A universe of annotated 3D objects. In IEEE/CVF Conference on Computer Vision and Pattern Recognition, CVPR, pages 13142-13153. IEEE, 2023, available online at doi.org/10.1109/CVPR52729. 2023.01263 (incorporated herein by reference); Matt Deitke, Ruoshi Liu, Matthew Wallingford, Huong Ngo, Oscar Michel, Aditya Kusupati, Alan Fan, Christian Laforte, Vikram Voleti, Samir Yitzhak Gadre, Eli VanderBilt, Aniruddha Kembhavi, Carl Vondrick, Georgia Gkioxari, Kiana Ehsani, Ludwig Schmidt, and Ali Farhadi. Objaverse-XL: A universe of 10M+ 3D objects. In Advances in Neural Information Processing Systems, 2023 (incorporated herein by reference); Sebastian Koch, Albert Matveev, Zhongshi Jiang, Francis Williams, Alexey Artemov, Evgeny Burnaev, Marc Alexa, Denis Zorin, and Daniele Panozzo. Abc: A big cad model dataset for geometric deep learning. In Proceedings of the IEEE/CVF conference on computer vision and pattern recognition, pages 9601-9611, 2019 (incorporated herein by reference); Tiange Luo, Chris Rockwell, Honglak Lee, and Justin Johnson. Scalable 3D captioning with pretrained models. arXiv preprint arXiv: 2306.07279, 2023 (incorporated herein by reference); Qingnan Zhou and Alec Jacobson. Thingi10k: A dataset of 10,000 3D-printing models. arXiv preprint arXiv: 1605.04797, 2016 (incorporated herein by reference); and Mikaela Angelina Uy, Quang-Hieu Pham, Binh-Son Hua, Thanh Nguyen, and Sai-Kit Yeung. Revisiting point cloud classification: A new benchmark dataset and classification model on real-world data. In Proceedings of the IEEE/CVF international conference on computer vision, pages 1588-1597, 2019 (incorporated herein by reference).) Notable ones include Objaverse 1.0 (See, e.g., Matt Deitke, Dustin Schwenk, Jordi Salvador, Luca Weihs, Oscar Michel, Eli VanderBilt, Ludwig Schmidt, Kiana Ehsani, Aniruddha Kembhavi, and Ali Farhadi. Objaverse: A universe of annotated 3D objects. In IEEE/CVF Conference on Computer Vision and Pattern Recognition, CVPR, pages 13142-13153. IEEE, 2023, available online at doi.org/10.1109/CVPR52729. 2023.01263 (incorporated herein by reference).) and Objaverse-XL (See, e.g., Matt Deitke, Ruoshi Liu, Matthew Wallingford, Huong Ngo, Oscar Michel, Aditya Kusupati, Alan Fan, Christian Laforte, Vikram Voleti, Samir Yitzhak Gadre, Eli VanderBilt, Aniruddha Kembhavi, Carl Vondrick, Georgia Gkioxari, Kiana Ehsani, Ludwig Schmidt, and Ali Farhadi. Objaverse-XL: A universe of 10M+ 3D objects. In Advances in Neural Information Processing Systems, 2023 (incorporated herein by reference).), with the former consisting of over 800K 3D models with higher quality textures and geometry types. The latter is a massive dataset of over ten million objects gathered from various sources, including Thingi10K and GitHub repositories. The diversity of objects in terms of shapes and categories is an advantage for ObjaverseXL. Most of the datasets currently used by the research community provide a single modality (meshes or voxels), and some include text descriptions and renderings for visual supervision tasks. However, none of the currently available datasets provide curated assets for encouraging research in the manufacturing domain. The largest public G-code dataset that the present inventors are aware of is the Greater G-code (See, e.g., Alayt Issak. Greater G-code. Kaggle dataset repository, 2022, available online at doi.org/10. 34740/kaggle/dsv/3970532 (incorporated herein by reference).) dataset, which only contains 860 G-code files paired with their STL renderings.

With increasing community usage, the present inventors envision the G-Forge database will grow over time, eventually serving as a valuable source of training data for a large multimodal foundation model specifically tuned for G-code. This can then be used to fine-tune the example LLM to provide a general-purpose service that includes one or more of the following use cases: (a) annotation and modernization of legacy G-Code files; (b) matching and parsing of similar parts/shapes found in a large repository of G-Code files; and/or (c) rapid retrieval of desired G-code files corresponding to a given text prompt. As an ancillary benefit, a sufficiently well-trained LLM can provide a line-by-line explanation—in human-understandable terms—of individual G-Code instructions (syntactic understanding), or even parse a complete G-Code file and answer. Using the generated dataset, a vector database that stores all the G-codes as vector embeddings from the LLMs can be created. These vector embeddings help in quick retrieval, debugging, and other downstream tasks. This objective can be divided into the following tasks.

### § 6.1.2 Facilitating Data Access and Retrieval from Example Multimodal Data Sets

Although creating the multimodal dataset has significant benefits, enabling efficient and scalable indexing and retrieval of G-code files is extremely beneficial for performing downstream tasks such as G-code completion, debugging, etc. In one example implementation, VectorDB (See, e.g., J. Cui, Z. Li, Y. Yan, B. Chen, and L. Yuan, “Chatlaw: Open-source legal large language model with integrated external knowledge bases,” arXiv preprint arXiv: 2306.16092, 2023 (incorporated herein by reference).), a vector database system that stores and queries high-dimensional vector embeddings obtained from LLMs, may be used to represent each G-code file as a vector that captures its semantic and geometric features. This, in turn, enables fast and accurate similarity search among G-code files based on their vectors to be performed, leading to fast retrieval, debugging, and other queries on the G-code.

A web-based platform may be provided in order to enable users to upload, download, search, and/or annotate G-code files. Such a web-based platform may also be used to provide tools for generating, editing, and/or visualizing G-code files, as well as performing various analyses and evaluations on them. Users can provide feedback and annotations on the G-code files, such as process parameters, material used for manufacturing, manufacturing cost, etc., via the web-based platform. Such user-generated data will enrich the content and quality of the G-code database, as well as enhance several downstream tasks such as translation to other G-code flavors, clustering similar parts together, classification of manufacturability, regression on manufacturing cost, etc.

### § 6.1.3 Example Method(s) for Debugging and Verifying Code

The quality of the output of 3D printers depends considerably on the correctness and efficiency of G-code, a low-level numerical control programming language that instructs 3D printers how to move and extrude material. Dedicated software can generate the G-code for a particular part from the computer-aided design (CAD) model. Still, the efficacy of the generated G-code to correctly 3D-print the desired part often depends on extensive manual tuning of such software. Moreover, iterative improvement of a given G-code file to produce 3D printed part that exactly matches the intended design is a non-trivial challenge. In addition, once generated, debugging of G-code files is extremely cumbersome. Since G-code is a low-level language, it is not very human-readable, and line-level commenting is often absent (or rare at best).

While simple programmatic solutions (such as regular expression matching) could be used to correct G-code errors, they are usually rigid and tailored to specific types of errors. A flexible general solution to these challenges has emerged via the recent advances of foundational AI and large language models (LLMs). These are powerful neural networks that can comprehend or generate natural language as well as code, trained on massive amounts of text data as well as code repositories. Therefore, they can be tuned to interpret, generate, and manipulate complex data types. Recent research has shown that natural language descriptions can be used for various tasks related to 3D printing, such as generating novel shapes (See, e.g., the documents: A. Sanghi, H. Chu, J. G. Lambourne, Y. Wang, C.-Y. Cheng, M. Fumero, and K. R. Malekshan, “Clip-Forge: Towards zero-shot text-to-shape generation,” in Proceedings of the IEEE/CVF Conference on Computer Vision and Pattern Recognition, 2022, pp. 18 603-18 613 (incorporated herein by reference); K. 0. Marshall, M. Pham, A. Joshi, A. Jignasu, A. Balu, and A. K. C. Hegde, “ZeroForge: Feedforward text-to-shape without 3D supervision,” arXiv preprint arXiv: 2306.08183, 2023 (incorporated herein by reference); A. Jain, B. Mildenhall, J. T. Barron, P. Abbeel, and B. Poole, “Zero-shot text-guided object generation with dream fields,” in Proceedings of the IEEE/CVF Conference on Computer Vision and Pattern Recognition, 2022, pp. 867-876 (incorporated herein by reference); and C.-H. Lin, J. Gao, L. Tang, T. Takikawa, X. Zeng, X. Huang, K. Kreis, S. Fidler, M.-Y. Liu, and T.-Y. Lin, “Magic3D: High-resolution text-to-3D content creation,” in Proceedings of the IEEE/CVF Conference on Computer Vision and Pattern Recognition, 2023, pp. 300-309 (incorporated herein by reference).), editing scenes (See, e.g., A. Haque, M. Tancik, A. A. Efros, A. Holynsk.i, and A. Kanazawa, “Instruct-NeRF2NeRF: editing 3D scenes with instructions,” arXiv preprint arXiv: 2303.12789, 2023. (incorporated herein by reference).), and reasoning about geometry in the volume space (See, e.g., J. Kerr, C. M. Kim, K. Goldberg, A. Kanazawa, and M. Tancik, “LeRF: Language embedded radiance fields,” arXiv preprint arXiv: 2303.09553, 2023 (incorporated herein by reference).). Since G-code is a low-level language that directly instructs the 3D printing process at a fine-grained level, our vision for LLM technology for G-code is valuable and distinct from these previous approaches. The only exception that the present inventors know of is the recent preprint (See, e.g., L. Makatura, M. Foshey, B. Wang, F. Hahn Lein, P. Ma, B. Deng, M. Tjandrasuwita, A. Spielberg, C. E. Owens, P. Y. Chen et al., “How can large language models help human s in design and manufacturing?” arXiv preprint arXiv: 2307.14377, 2023. (incorporated herein by reference).).

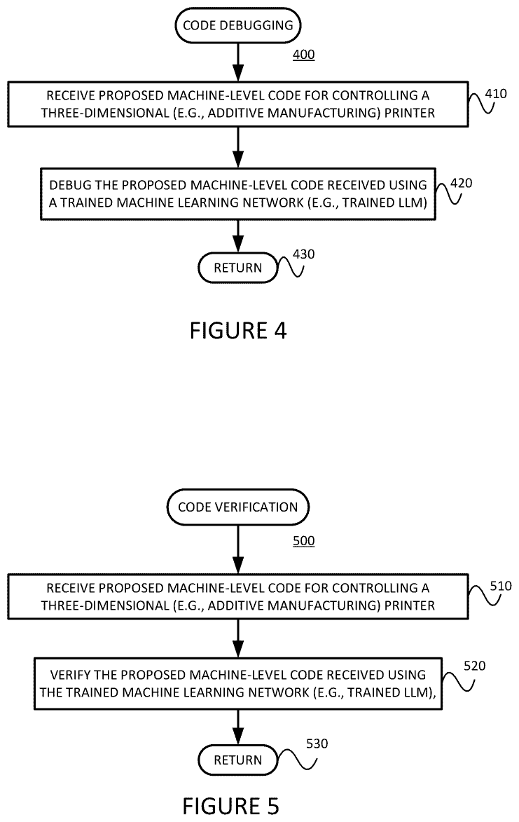

FIG. 4 is a flow chart of an example method 400 for using a trained LLM to debug code. As shown, the example method 400 receives proposed machine-level code for controlling a three-dimensional (e.g., additive manufacturing) printer (Block 410), and debugs the proposed machine-level code received using the trained machine learning network (e.g., trained LLM) (Block 420).

FIG. 5 is a flow chart of an example method 500 for using a trained LLM to verify code. As shown, the example method 500 receives proposed machine-level code for controlling a three-dimensional (e.g., additive manufacturing) printer (Block 510), and verifies the proposed machine-level code received using the trained machine learning network (e.g., trained LLM) (Block 520).

As illustrated in FIG. 6, system 610, including the multimodal database 612 and trained LLM 614 can provide a verification and/or debugging services. The multimodal database 612 may be initially seeded with models from existing datasets, such as those listed in § 6.1.1 above. The multimodal database 612 will grow over time as it is used by the community of users. The system 610 provides a foundation of a larger platform (like a Google for Manufacturing) on top of which numerous applications can be built. The following features enable this.

One component of the system 610 is a software interface, powered by a the LLM 614 trained on the multimodal database 612, that can assess whether the part specified in a given G-Code file is valid (or not) for a particular machine tool (whose specifications are provided either in the form of a CAD model, or text prompts). Such a verifier can be directly used to debug incorrect G-code instructions, as well as identify portions of a G-code file that incorrectly reflect the corresponding CAD model. These debugging and/or verification services will especially help small and medium-scale manufacturers to verify their manufacturing process plans, reduce any material wastage, and scale up their processes.

The present inventors have performed a comprehensive evaluation of the state-of-the-art LLMs for debugging and modifying G-code files for extrusion-based additive manufacturing (AM). A major limitation of current LLMs is their limited context window length: they struggle with handling the thousands of lines that G-code files typically possess. (See also, Appendix A of the '928 provisional.) Hence, the present inventors devise novel serialization approaches for LLMs to handle low-level control language inputs. The evaluation by the inventors focused on six (6) pre-trained LLMs: GPT-3.5; GPT-4; Bard; Claude-2; Llama-2-70b; and Starcoder.

The inventors' preliminary evaluations revealed distinct differences between the capabilities of the current state-of-the-art LLMs for G-code comprehension. While the best and largest language models exhibit reasonable proficiency in debugging, performing geometric transformations, and reasoning, they also depict their critical limitations. In particular, the present inventors found that GPT-4 performed the best, followed by Claude-2. Crucially, open-source LLMs (i.e., Llama-2-70b and Starcoder) performed poorly across tasks compared to closed-source models.

Based on the evaluation of the different LLMs by the present inventors, a custom LLM tuned specifically for G-code is described. Example multimodal databases, such as the one described in § 6.1.1. above, may be created. These datasets may contain tessellated geometries that are then sliced to generate model-specific G-code. Scaling G-code generation, considering the data-intensive nature of LLMs, is challenging. However, a batch-wise G-code generation technique that addresses this challenge is described. Prusa's command-line interface may be used for slicing to ensure batchwise conversion and uniformity during large-scale slicing by standardizing configuration parameters.

Since our example multimodal dataset 612 amalgamates diverse datasets, this ensures that the LLM 614 becomes proficient in a spectrum of G-code related semantic and syntactic tasks. Generating a bespoke LLM for G-code verification and debugging needs a G-code dataset capable of encapsulating a plethora of geometric variations and features, and large and robust computing resources. However, using pre-trained versions of LLMs such as Llama (See, e.g., H. Touvron, T. Lavril, G. Izacard, X. Martinet, M.-A. Lachaux, T. Lacroix, B. Roziere, N. Goyal, E. Hambro, F. Azhar, A. Rodriguez, A. Joulin, E. Grave, and G. Lample, “LLaMA: Open and efficient foundation language models,” 2023 (incorporated herein by reference).) or Llama-2 (Sec, e.g., H. Touvron, L. Martin, K. Stone, P. Albert, A. Almahairi, Y. Babaci, N. Bashlykov, S. Batra, P. Bhar-gava, S. Bhosale et al., “LLaMA 2: Open foundation and fine-tuned chat models,” arXiv preprint arXiv: 2307.09288, 2023 (incorporated herein by reference).) is expected to be effective. Such a pre-trained model negates the need for base training, ensuring a bespoke LLM for code debugging and verification inherits an innate ability to reason and task generalization capability. The subsequent step involves fine-tuning the large language model using our curated G-code dataset, equipping the LLM to proficiently address G-code-specific prompts. This dual-phase approach—pre-training followed by fine-tuning—ensures that our example LLM, customized for debugging and/or verifying G-code, benefits from a combination of holistic knowledge and task-specific expertise.

### § 6.1.4 Example Method(s) for Translating One “Flavor” or Code to Another “Flavor”

As an extension to the system 600 illustrated in FIG. 6, an example LLM interface can also be leveraged as a mechanism to translate between G-code “flavors” for different machine tool controllers. G-code translation involves converting a G-code from one flavor to another while preserving the necessary context associated with each flavor and finding a correspondence between any two given flavors of G-code.

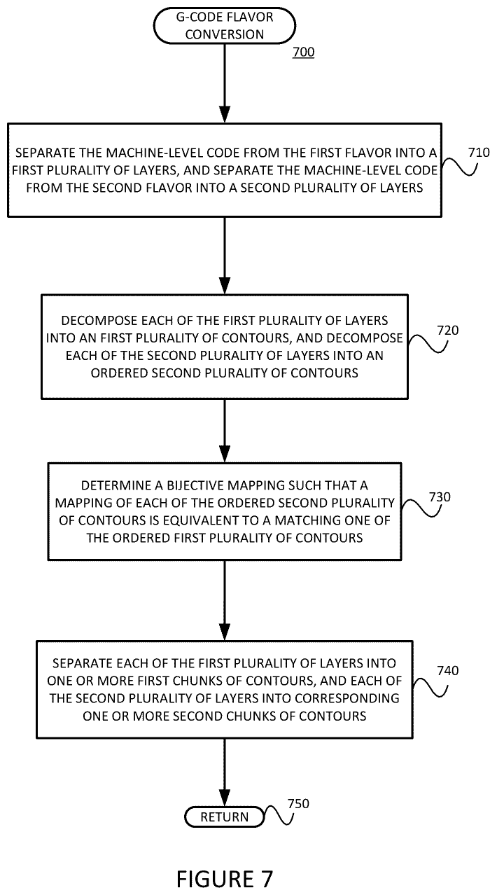

FIG. 7 is flow chart of an example method 700 for training a machine learning network (e.g., a large language model (LLM)), using the (e.g., multimodal) information sets, to translate machine-level code from a first “flavor” (e.g., a first 3D printer make and/or model) to a second “flavor”. The example method 700 separates the machine-level code from the first flavor into a first plurality of layers, and separates the machine-level code from the second flavor into a second plurality of layers. (Block 710) Each of the first plurality of layers is decomposed into an first plurality of contours, and each of the second plurality of layers is decomposed into an ordered second plurality of contours. (Block 720) The example method 700 then determines a bijective mapping such that a mapping of each of the ordered second plurality of contours is equivalent to a matching one of the ordered first plurality of contours. (Block 730) Finally, the example method 700 separates each of the first plurality of layers into one or more first chunks of contours, and each of the second plurality of layers into corresponding one or more second chunks of contours. (Block 740)

Referring back to block 730, in one example implementation of the example method 700, the act of determining the bijective mapping includes finding, for each of the ordered first plurality of contours, a matching contour from the ordered second plurality of contours. In one example, the matching contours from the ordered first and second plurality of contours have matching extrusion location coordinates. In one example, the matching contours from the ordered first and second plurality of contours have matching extrusion location coordinates and at least one adjacent line in the contour with matching extrusion location coordinates. In one example implementation, the act of finding a matching contour uses an lookup table mapping lines of the machine-level code to indices of the contours from the ordered second plurality of contours.

Consider two different flavors of G-code—Sailfish and Marlin. Sailfish is a legacy G-code format that is not currently used by the 3D printing community. Marlin is a modern G-code format that has been heavily adopted, In some cases, other G-code flavors are built on top of Marlin. Given this, in one example implementation, the example dataset is leveraged to finetune GPT-2 for the task of G-code translation from Sailfish to Marlin. G-code is inherently a low-level language, and for a task like translation, the quality of data being fed into an LLM has a significant impact on its performance. Consequently, it is useful to perform some data pre-processing (See, e.g., § 6.1.4.1 below.) to effectively maintain the context across lines of G-code.

### § 6.1.4.1 Data Pre-Processing Methods

A major challenge in applying language-modeling-based techniques to G-code is the length of G-code files. While a shape's G-code representation can be separated into layers (which do not share information and can therefore be handled independently), separating into layers is still not sufficient because even a single layer from our multimodal dataset can be over the token limit (or context length). A “token limit” refers to the maximum number of tokens that the LLM can process in a single input or output. Tokens are the basic units of text that the LLM understands, which can be as short as one character or as long as one word, depending on the language and context. For instance, the phrase “I love ice cream” would typically be broken down into tokens like {“I”, “love”, “ice”, “cream”}. The token limit affects how much information can be fed into the model at once and how long the model's responses can be. Exceeding this limit usually means that the input will be truncated or that the model will not generate a response for the excess tokens, which can impact the quality and completeness of the output. Different models have different token limits. Therefore, example methods consistent with the present description further split G-code layers, allowing the decomposition of mappings between G-code files into a series of mappings between smaller G-code portions. Such example methods can be applied to different G-codes regardless of the variants they are written in, while ensuring that the resulting pairs of G-code segments represent the same spatial semantics. One example implementation accomplishes this by (1) permuting the contours in each G-code layer so that they have the same ordering, and (2) then adaptively selecting portions to create matching pairs. Example ways to perform each of these preprocessing steps are described below.

### § 6.1.4.1.1 Contour Preprocessing

Contour flipping preprocessing may be performed as follows. Let L_{A} and L_{B} be two G-code layers which use different flavors to represent the same 3D information. Each of these layers (L_{A} and L_{B}) can be decomposed into a series of N contours c₁^{(A)}, . . . c_{N}^{(A)} and c₁^{(B)}, . . . c_{N}^{(B)}, each represented using their respective flavor. Disregarding the difference in flavors, both sequences contain the same set of unique contours. Consequently, one can define a bijective mapping M: [N]→[N] such that the contour c_{M(i)}^{(B)} is equivalent to cᵢ^{(A)}.

The primary preprocessing challenge is to find this bijection which, once found, allows the contours of L_{B} to be reordered so that ∀i ∈ [N], cᵢ^{(B)} is equivalent to cᵢ^{(B)}. To determine M, each contour cᵢ^{(A)} in L_{A} is iterated over and its corresponding contour c_{M(i)}^{(B)} in L_{B} is found. Two contours are said to be matching if there are specific commands which are included in both. More specifically, one example method represents a single line of G-code so that identical representations will indicate matching contours.

To minimize the possibility of a duplicate representation (that could lead to a false match), this criteria is based on G-code lines which contain commands to extrude at specified coordinates. Other commands are disregarded as they are likely to be repeated throughout a file or contain syntax which differs across flavors. In contrast, extrusion locations are specified using floating point coordinates with several digits of precision making it rare for the same point to appear in different contours. The possibility of duplicate locations is accounted for by concatenating the line's coordinates with the next two lines in the contour, where possible. If these following lines do not contain a location-specific extrusion command, a token denoting an empty line is included in their place. Taken together, these steps create a string representation of each line that strips away flavor-specific syntax while including enough contextual information to prevent unwanted duplicates.

Using this consistent characterization of G-code lines allows contours to be matched by simply finding a single pair of lines with the same representation. However, due to the length of G-code layers, it is highly inefficient to consider all possible pairs of lines when looking to match contours. To alleviate this, a lookup table is precomputed for L_{B}. For each line of a contour c_{B}⁽ⁱ⁾, the lookup table maps from the line representation to the index i. Then, when iterating over the contours of L_{A}, the representation for each line is computed and the lookup table is searched. If there is a match, then these indices are added to the bijection M. Although this contour flipping method cannot be guaranteed to always find the correct bijection M due to variations amongst some contours, it was found to be highly reliable, producing aligned G-code for over 99.9% of the G-code layers in one example dataset. Pseudocode for an example contour flipping process is provided here:

| | |
|---|---|
| 1: | procedure CONTOURFLIP(LayerA,LayerB) |
| 2: | ContoursA ← ContourSplit(LayerA) |
| 3: | ContoursB ← ContourSplit(LayerB) |
| 4: | Lookup ← HashMap( ) [symbol] Create hash index of contours |
| | in Layer B |
| 5: | for c + 1 to length(ContoursB) do |
| 6: | for i ← 1 to length(ContoursB[c]) do |
| 7: | linei ← representation(ContoursB[c][i]) |
| 8: | if linei ∈ Lookup and Lookup[linei] /= i then |
| 9: | Delete Lookup[linei] |
| 10: | else |
| 11: | Lookup[linei] ← c |
| 12: | end if |
| 13: | end for |
| 14: | end for |
| 15: | Mapping ← HashMap( ) [symbol] Find bijection between layers |
| 16 | for cA ← 1 to length(ContoursA) do |
| 17: | for i ← 1 to length(ContoursA[cA]) do |
| 18: | linei ← representation(ContoursA[cA][i]) |
| 19: | if linei ∈ Lookup then |
| 20: | cB ← Lookup[linei] |
| 21: | Mapping[cB] ← cA |
| 22: | end if |
| 23: | end for |
| 24: | end for |
| 25: | FlippedB ← Array[length(ContoursB[cA])] |
| 26 | for i ← 1 to length(ContoursB) do |
| 27: | FlippedB[Mapping[ci]] ← ContoursB[i] |
| 28: | end for |
| 29: | return LayerA,FlippedB |
| 30: | end procedure |

### § 6.1.4.1.2 Pair Creation Preprocessing

Pair creation preprocessing may be performed as follows. Given two G-code layers which have undergone contour flipping so that they have the same high-level semantic ordering, one can reasonably expect to divide them each into pairs of contiguous sections sharing the same 3D information. Because there are often commands included in one flavor but not the other, one cannot simply select portions of equal length and expect them to be translatable. Instead, the cutoff points for each section are determined adaptively.

Here, the layers are represented as sequences of lines, with L_{A}= [symbol] ₗ^{(A)}, . . . , [symbol] _{N}^{(A)} and L_{B}= [symbol] ₗ^{(B)}, . . . , [symbol] _{N}^{(B)}. The goal of separating these layers into K matching chunks then amounts to finding pairs of delimiting line indices (kᵢ^{A}, kᵢ^{b})ᵢ₌₁^{K} so that the resulting G-code segments [symbol] ₖ_{ₗ}_{^{A}}^{(A)}, . . . , [symbol] ₖ_{ᵢ₌₁}_{^{A}}₋₁^{(A)} and [symbol] ₖ_{ᵢ}_{^{B}}^{(B)}, . . . , [symbol] ₖ_{ᵢ₌₁}_{^{B}}₋₁^{(B)} meet our requirements. In particular, the segments can be ensured to contain all the same content as long as the beginning and end lines of each language correspond to the same commands.

One example pair creation approach consistent with the present description finds these matching line indices while respecting a maximum length parameter. Pseudocode for an example pair creation process is provided here:

| | |
|---|---|
| 1: | procedure PAIR CREATION(LayerA,LayerB,maxLength) |
| 2: | starti,startj ← 0,0 |
| 3: | endi ← maxLength |
| 4: | pairs ← List( ) |
| 5: | while starti <= length(LayerA) do |
| 6: | endj ← startj + 1 |
| 7: | found ← False |
| 8: | while ¬found and (endj − startj) ≤ maxLength do |
| 9: | if representation(LayerA[endi]) = |
| | representation(LayerB[endj]) then |
| 10: | found ← True |
| 11: | end if |
| 12: | endj = endj + 1 |
| 13: | end while |
| 14: | if found then [symbol] Add matching pair of chunks to dataset |
| 15: | chunka ← LayerA[starti : endi] |
| 16: | chunkb ← LayerB[startj : endj] |
| 17: | pairs.append((chunka,chunkb)) |
| 18: | else |
| 19: | endi = endi −1 [symbol] Could not find a line matching line |
| | endi, try a smaller chunk |
| 20: | end if |
| 21: | end while |
| 22: | return LayerA,FlippedB |
| 23: | end procedure |

In short, index kᵢ₊₁^{A} is found iteratively by starting with a candidate value which is kᵢ₊₁^{A} plus the maximum length. Finding a matching line in L_{B} is then attempted. If successful, these line indices are considered to be a matching pair. If a matching line cannot be found for the candidate, the candidate line index is decremented by one, and continues trying to find a matching line. A line representation similar to the one used for contour flipping is used to determine whether a pair of lines are matching.

### § 6.1.4.1.3 Preprocessing to Handle Extrusion Values

Preprocessing to handle extrusion values may be performed as follows. The previously described preprocessing methods may be used to create pairs of G-code chunks which represent the same local information. Therefore, translating between these pairs of G-code chunks is possible. However, there is an additional non-local dependence which should be accounted for in the G-code; namely, extrusion values. More specifically, in addition to telling the 3D printer where to move, a line of G-code also tells it how much material to extrude during this movement. This is specified through an “E” command which states how much total material will have been extruded once that point is reached. For instance, if one line of G-code contains an E value of 3.0 and the next line has an E value of 3.1, then 0.1 units of material should be extruded during this movement. There are also specialized language-specific commands throughout a shape's G-code which reset the total extrusion values to some smaller constant.

Because these values represent a cumulative sum of all material extruded up to that point starting from the most recent reset value, there is a non-locality element that should be addressed. More specifically, during preprocessing, each extrusion value may be amended by subtracting the previous line's extrusion value. This new value is referred to as the “relative extrusion”. This represents only the amount of material that is to be extruded during this movement and allows for any translation model to learn a simple local mapping that is not dependent on other chunks. Finally, after generating G-code in this relative form, it is converted back to its original format by computing its cumulative sum.

### § 6.1.5 Example Method(s) for Generating Code from A Three-Dimensional Representation of an Object and/or from a Human Language Description of the Object

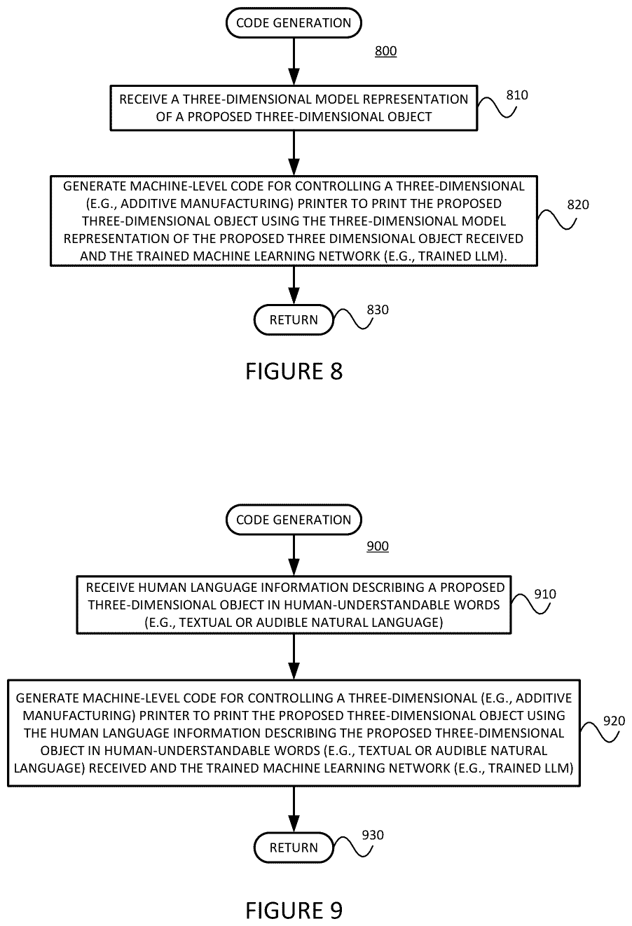

FIGS. 8 and 9 are flow charts of example methods 800 and 900, respectively, for using a trained LLM to generate code. The example method 800 of FIG. 8 includes receiving a three-dimensional model representation of a proposed three-dimensional object (Block 810), and generating machine-level code for controlling a three-dimensional (e.g., additive manufacturing) printer to print the proposed three-dimensional object using the three-dimensional model representation of the proposed three dimensional object received and the trained machine learning network (e.g., trained LLM) (Block 820). The example method 900 of FIG. 9 includes receiving human language information describing a proposed three-dimensional object in human-understandable words (e.g., textual or audible natural language) (Block 910), and generating machine-level code for controlling a three-dimensional (e.g., additive manufacturing) printer to print the proposed three-dimensional object using the human language information describing the proposed three-dimensional object in human-understandable words (e.g., textual or audible natural language) received and the trained machine learning network (e.g., trained LLM) (Block 920).

To address this need, a large multi-modal foundation model that can learn from both text and image modalities of G-code files is described. A foundation model is a type of machine learning model that learns from a wide range of data using self-supervision at scale. Foundation models have shown remarkable capabilities in natural language processing, computer vision, and multimodal AI. (See, e.g., H. Lu, Q. Zhou, N. Fei, Z. Lu, M. Ding, J. Wen, C. Du, X. Zhao, H. Sun, H. He, and J.-R. Wen, “Multimodal foundation models are better simulators of the human brain,” 2022 (incorporated herein by reference).) However, as best understood by the present inventors, there is no existing foundation model that is specifically designed for G-code analysis.

### § 6.1.6 Example Method(s) for Retrieving Similar Parts

Matching and parsing of similar parts and/or shapes found in a large repository of G-Code files are possible using the example system 600 of FIG. 6. For example, the example foundation model can compare and rank G-code files based on their similarity in terms of geometry, function, and/or features. It can also parse and segment G-code files into meaningful subparts and/or operations that can be reused and/or modified.

### § 6.1.7 Scaling

Scaling is considered to be a simple geometric transformation that results in a geometry being enlarged or reduced depending on a scaling factor. The following assumes uniform scaling along all three principle directions (X, Y, and Z). The present inventors evaluated the ability of current chat-based LLMs to perform this simple linear transformation by providing them with a single layer of G-code and asking the prompts:

i) Can you scale the coordinates by a factor of 2 and give me the updated G-code?

ii) Can you scale the entire layer by a factor of 2 and return the updated G-code? During this evaluation, the present inventors empirically arrived at the maximum number of lines of G-code an LLM in a test suite could accept before crossing their respective token limits. This fact is leveraged to chunk the G-code before feeding it to an LLM.

### § 6.2 Example Apparatus

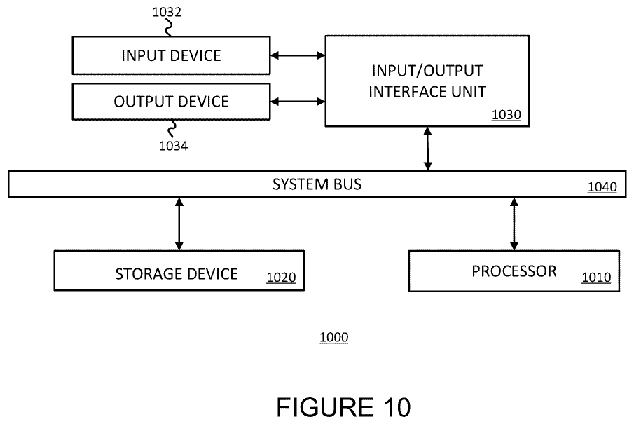

The example system 1000 of FIG. 10 may perform one or more of the processes described, and/or store information used and/or generated by such processes. The exemplary system 1000 includes one or more processors 1010, one or more input/output interface units 1030, one or more storage devices 1020, and one or more system buses and/or networks 1040 for facilitating the communication of information among the coupled elements. One or more input devices and one or more output devices may be coupled with the one or more input/output interfaces (e.g., to a display, button, motor(s), app based UIs, etc. The one or more processors may execute machine-executable instructions (e.g., Python, C, C++, etc.) to perform one or more aspects of the example embodiments consistent with the present description. At least a portion of the machine executable instructions may be stored (temporarily or more permanently) on the one or more storage devices and/or may be received from an external source via one or more input interface units. The machine executable instructions may be stored as various software modules, each module performing one or more operations. Functional software modules are examples of components of the invention.

In some embodiments consistent with the present invention, the processors may be one or more microprocessors and/or ASICs. The bus may include a system bus. The storage devices may include system memory, such as read only memory (ROM) and/or random access memory (RAM). The storage devices may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine readable medium for storing the machine-executable instructions. The machine readable medium may be non-transitory and may include, but is not limited to, flash memory, optical disks, CD ROMs, DVD ROMs, RAMS, EPROMS, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network collection) and stored on a non-transitory storage medium. The machine-readable medium may also be referred to as a processor-readable medium.

Example embodiments consistent with the present description might be implemented in hardware, such as one or more field programmable gate arrays (“FPGA”s), one or more integrated circuits such as ASICs, one or more network processors, etc. Alternatively, or in addition, embodiments consistent with the present description might be implemented as stored program instructions executed by a processor. Such hardware and/or software might be provided in a laptop computer, desktop computer, a server, a tablet computer, a mobile phone, or any device that has computing capabilities and that can perform the foregoing method(s).

### § 6.3 Refinements, Alternatives, and/or Extensions

The broader impacts of the present description extend beyond manufacturing. For example, the use of multimodal LLMs can be extended to other research areas where training new personnel on the process workflow is difficult, such as in medical image processing or non-destructive evaluation.

The example LLM-powered multimodal database(s) for manufacturing harnesses the data revolution by developing new machine learning (ML) methods to enable real-time model retrieval. The present description is useful in integrating data analytics and manufacturing. The primary impact of this will be bridging advances in ML that directly address the national mandate on manufacturing. The methodologies and insight for understanding, predicting, and controlling layered manufacturing are applicable beyond those described here, and provide the foundational knowledge for transformative advances for manufacturing. Coupled data and hypothesis-driven approaches for CAD model retrieval using G-code without explicit feature handcrafting will impact manufacturing design. The principled integration of ML models with domain knowledge provide bidirectional advances in ML and cyber manufacturing systems.

Although example implementations have been described in the context of additive manufacturing such as 3D printing, they can be applied to subtractive manufacturing instead, or in addition.

### § 6.4 Conclusions

The example foundation models described leverage the example multimodal database, which includes a curated collection of over one million G-code files with rich metadata and annotations. Each G-code file in the example multimodal database is associated with an image of the final part, a textual description of the part's function and features, and a set of tags that indicate the part's category, material, machine type, and toolpath strategy.

The example multimodal databases may be used as the main source of training data for the example foundation model. The example multimodal databases may be augmented with synthetic data generated by the large language model that can produce realistic G-code files from natural language prompts. The example LLMs may be fine-tuned on a subset of the G-Forge database based on the foregoing. The example LLMs may also be used to generate natural language descriptions and tags from G-code files, which can be used to enrich the database. By training the foundation model on an example multimodal database and its augmentations, a general-purpose service can support the following key practical use cases:
(1) Annotation and modernization of legacy G-Code files: The example foundation model can automatically generate natural language descriptions and tags for any given G-code file, as well as suggest improvements or optimizations for the file based on best practices and standards.
(2) Matching and parsing of similar parts/shapes found in a large repository of G-Code files: The example foundation model can compare and rank G-code files based on their similarity in terms of geometry, function, or features. It can also parse and segment G-code files into meaningful subparts or operations that can be reused or modified.
(3) Rapid retrieval of desired G-code files corresponding to a given text prompt: The example foundation model can understand natural language queries and retrieve relevant G-code files. It can also generate new G-code files from scratch or by adapting existing ones.

As an ancillary benefit, a sufficiently well-trained foundation model can provide a line-by-line explanation—in human-understandable terms—of individual G-Code instructions (syntactic understanding), or even parse a complete G-Code file and answer higher-level queries about the geometry of the given part (semantic understanding).

The integration of modern large language models (LLMs) in manufacturing is of immense impact. The systems and methods described can lead ways to develop an assembly line layout that optimizes for constraints like minimizing production time, robust quality assurance, and efficient resource utilization. For example, an inexperienced assembly line technician could query the trained LLM to generate a comprehensive assembly manual based on the CAD model and the manufacturing specification. Furthermore, engineers could interact with process planning software using natural language, enabling the efficient creation and modification of the process steps. This approach allows for the early identification of potential issues and provides step-by-step fixes in real time, effectively reducing errors and delays. Moreover, these models could be used to accurately predict equipment failures and maintenance requirements, allowing for proactive intervention and reduced downtime. Their ability to detect and suggest fixes can be utilized to generate training material for new and existing assembly-line workers. In this manner, the systems and methods described may be used to provide a valuable AI-powered assistant for users throughout the entire manufacturing pipeline, being responsive to user queries, redefining traditional workflows, and significantly reducing errors and costs.

What is claimed is:

1. A computer-implemented method comprising:
a) receiving, for each of a plurality of three-dimensional objects, a multimodal information set including
1) a three-dimensional model representation of the three-dimensional object,
2) human language information describing the three-dimensional object in human-understandable words, and
3) machine-level code for controlling a three-dimensional printer to print the three-dimensional object;
b) defining a data structure entry by grouping, for each of the information sets,
1) the three-dimensional model representation of the three-dimensional object,
2) the human language information describing the three-dimensional object in human-understandable words, and
3) the machine-level code for controlling a three-dimensional printer to print the three-dimensional object; and
c) training a machine learning network using the multimodal information sets, to perform at least one of
(A) debugging machine-level code for controlling a three-dimensional printer,
(B) verifying machine-level code for controlling a three-dimensional printer,
(C) translating machine-level code from a first flavor to a second flavor,
(D) generating machine-level code for controlling a three-dimensional printer from at least one of (i) a three-dimensional model representation of the three-dimensional object, and/or (ii) human language information describing the three-dimensional object in human-understandable words,
(E) generating a human-understandable explanation of machine-level code for controlling a three-dimensional printer, from the machine-level code for controlling a three-dimensional printer, or
(F) generating a three-dimensional model of an object from machine level-code for controlling a three-dimensional printer,
to generate a trained machine learning network.

2. The computer-implemented method of claim 1, further comprising:
d) receiving proposed machine-level code for controlling a three-dimensional printer; and
e) debugging or verifying the proposed machine-level code received using the trained machine learning network.

3. The computer-implemented method of claim 1, further comprising:
d) receiving a three-dimensional model representation of a proposed three-dimensional object; and
e) generating machine-level code for controlling a three-dimensional printer to print the proposed three-dimensional object using the three-dimensional model representation of the proposed three dimensional object received and the trained machine learning network.

4. The computer-implemented method of claim 1, further comprising:
d) receiving human language information describing a proposed three-dimensional object in human-understandable words; and
e) generating machine-level code for controlling a three-dimensional printer to print the proposed three-dimensional object using the human language information describing the proposed three-dimensional object in human-understandable words received and the trained machine learning network.

5. The computer-implemented method of claim 1, wherein, in each case, the machine-level code for controlling a three-dimensional printer to print the three-dimensional object specifies a sequence of (1) a print head positions, and (2) an amount of material for the print head to extrude at the print head positions specified.

6. The computer-implemented method of claim 5, wherein the print head position is specified by one of (A) an absolute position, or (B) a position relative to an immediately previous position.

7. The computer-implemented method of claim 5, wherein the machine-level code for controlling a three-dimensional printer to print the three-dimensional object is G-code.

8. The computer-implemented method of claim 1, wherein, in each case, the human language information describing the three-dimensional object in human-understandable words are answers to a set of prompts about the three-dimensional object.

9. The computer-implemented method of claim 8, wherein the set of prompts about the three-dimensional object include at least one of (A) a category of the three-dimensional object, (B) a material of the three-dimensional object, (C) a toolpath strategy for printing the three-dimensional object with a three-dimensional printer, and/or (D) a geometric description of the three-dimensional object.

10. The computer-implemented method of claim 1, wherein the act of training a machine learning network using the multimodal information sets to perform at least one of
(A) debugging machine-level code for controlling a three-dimensional printer,
(B) verifying machine-level code for controlling a three-dimensional printer,
(C) translating machine-level code from a first flavor to a second flavor,
(D) generating machine-level code for controlling a three-dimensional printer,
(E) generating a human-understandable explanation of machine-level code for controlling a three-dimensional printer, from the machine-level code for controlling a three-dimensional printer, or
(F) generating a three-dimensional model of an object from machine level-code for controlling a three-dimensional printer,
to generate a trained machine learning network, includes tokenizing the machine-level code for controlling a three-dimensional printer to print the three dimensional object into machine-level code corresponding to at least two contiguous printer nozzle positions.

11. The computer-implemented method of claim 1, wherein each of the three-dimensional model representations of a three-dimensional object is parsed into layers.

12. The computer-implemented method of claim 11, wherein, in each case, the human language information describing the three-dimensional object in human-understandable words are answers to a set of prompts about one or more of the layers.

13. The computer-implemented method of claim 1, wherein the act of receiving, for each of a plurality of three dimensional objects, a multimodal information set includes
receiving the three dimensional model representation of the three dimensional object,
generating, as the machine level code for controlling a three dimensional printer to print the three dimensional object, G-code from the three dimensional model by (1) slicing the three dimensional model to generate a plurality of slices, and (2) generating G-code for each of the plurality of slices,
generating a plurality of rendered views of the three dimensional model,
generating, as the human language information describing the three dimensional object in human-understandable words, categories derived from text embeddings determined from automatic captions generated using vision language models trained using the Large Vocabulary Instance Segmentation (LVIS) dataset and image embeddings from each of the plurality of rendered view of the three dimensional model.

14. The computer-implemented method of claim 1 wherein the act of training a machine learning network, using the multimodal information sets, to perform translating machine-level code from a first flavor to a second flavor, includes
separating the machine-level code from the first flavor into a first plurality of layers, and separating the machine-level code from the second flavor into a second plurality of layers,
decomposing each of the first plurality of layers into an first plurality of contours, and decomposing each of the second plurality of layers into an ordered second plurality of contours,
determining a bijective mapping such that a mapping of each of the ordered second plurality of contours is equivalent to a matching one of the ordered first plurality of contours, and
separating each of the first plurality of layers into one or more first chunks of contours, and each of the second plurality of layers into corresponding one or more second chunks of contours.

15. The computer-implemented method of claim 14, wherein the act of determining the bijective mapping includes
finding, for each of the ordered first plurality of contours, a matching contour from the ordered second plurality of contours.

16. The computer-implemented method of claim 15, wherein the matching contours from the ordered first and second plurality of contours have matching extrusion location coordinates.

17. The computer-implemented method of claim 15, wherein the matching contours from the ordered first and second plurality of contours have matching extrusion location coordinates and at least one adjacent line in the contour with matching extrusion location coordinates.

18. The computer-implemented method of claim 15, wherein the act of finding a matching contour uses an lookup table mapping lines of the machine-level code to indices of the contours from the ordered second plurality of contours.

19. A device comprising:
a) at least one processor; and
b) a non-transitory storage system storing processor-executable instructions which, when executed by the at least one processor, cause the at least one processor to perform a computer-implemented method comprising:
1) receiving, for each of a plurality of three-dimensional objects, a multimodal information set including
A) a three-dimensional model representation of the three-dimensional object,
B) human language information describing the three-dimensional object in human-understandable words, and
C) machine-level code for controlling a three-dimensional printer to print the three-dimensional object;
2) defining a data structure entry by grouping, for each of the information sets,
A) the three-dimensional model representation of the three-dimensional object,
B) the human language information describing the three-dimensional object in human-understandable words, and
C) the machine-level code for controlling a three-dimensional printer to print the three-dimensional object; and
3) training a machine learning network using the multimodal information sets, to perform at least one of
(i) debugging machine-level code for controlling a three-dimensional printer,
(ii) verifying machine-level code for controlling a three-dimensional printer,
(iii) translating machine-level code from a first flavor to a second flavor,
(iv) generating machine-level code for controlling a three-dimensional printer from at least one of a three-dimensional model representation of the three-dimensional object, and/or human language information describing the three-dimensional object in human-understandable words,
(v) generating a human-understandable explanation of machine-level code for controlling a three-dimensional printer, from the machine-level code for controlling a three-dimensional printer, or
(vi) generating a three-dimensional model of an object from machine level-code for controlling a three-dimensional printer,
to generate a trained machine learning network.

20. A computer-readable non-transitory storage system storing processor-executable instructions which, when executed by at least one processor, cause the at least one processor to perform a computer-implemented method comprising:
a) receiving, for each of a plurality of three-dimensional objects, a multimodal information set including
1) a three-dimensional model representation of the three-dimensional object,
2) human language information describing the three-dimensional object in human-understandable words, and
3) machine-level code for controlling a three-dimensional printer to print the three-dimensional object;
b) defining a data structure entry by grouping, for each of the information sets,
1) the three-dimensional model representation of the three-dimensional object,
2) the human language information describing the three-dimensional object in human-understandable words, and
3) the machine-level code for controlling a three-dimensional printer to print the three-dimensional object; and
c) training a machine learning network using the multimodal information sets, to perform at least one of
(A) debugging machine-level code for controlling a three-dimensional printer,
(B) verifying machine-level code for controlling a three-dimensional printer,
(C) translating machine-level code from a first flavor to a second flavor,
(D) generating machine-level code for controlling a three-dimensional printer from at least one of (i) a three-dimensional model representation of the three-dimensional object, and/or (ii) human language information describing the three-dimensional object in human-understandable words,
(E) generating a human-understandable explanation of machine-level code for controlling a three-dimensional printer, from the machine-level code for controlling a three-dimensional printer, or
(F) generating a three-dimensional model of an object from machine level-code for controlling a three-dimensional printer,
to generate a trained machine learning network.
